(19) United States
(12) Patent Application Publication
(10) Pub. No.: US 2013/0342503 A1
(43) Pub. Date: Dec. 26, 2013

(54) Signal Enhancing Method for Capacitive Touch Panel of Mobile Device

(71) Applicant: Inputek Co., Ltd., Hsinchu County (TW)

(72) Inventors: Chun Yu CHEN, Hsinchu County (TW); Chang Kuang CHUNG, Hsinchu County (TW); Ming Hui HUNG, Hsinchu County (TW); Po Hsuan CHIANG, Hsinchu County (TW)

(21) Appl. No.: 13/921,968

(22) Filed: Jun. 19, 2013

Related U.S. Application Data
(60) Provisional application No. 61/661,979, filed on Jun. 20, 2012.

(51) Int. Cl. G06F 3/044

(52) U.S. Cl. CPC G06F 3/044
USPC 345/174

(57) ABSTRACT

A signal enhancing method for capacitive touch panel of mobile device provides a reference potential by a reference bar that is next to a sensor bar, wherein when the reference potential is a ground potential, the reference bar becomes a ground (GND) bar. The sensor bar and GND bar may comprise a plurality of tiny sensor bars and a plurality of tiny GND bars, respectively; and may further comprise fishbone sensor bars and fishbone GND bars. The plurality of tiny sensor bars and plurality of tiny GND bars are arranged in an alternative disposition. In this way, when a touch panel is touched, a tiny sensor bar and adjacent tiny GND bar are both touched so as to obtain a large coupling capacitance.

The current application claims a priority to the U.S. Provisional Patent Application Ser. No. 61/661,979, filed on Jun. 20, 2012.

### FIELD OF THE INVENTION

The present invention relates to a system and a method for enhancing touch panel signal. In particular, it relates to a method for enhancing signal of capacitive touch panel in a mobile device by providing a ground (GND) reference potential.

### BACKGROUND OF THE INVENTION

Touchscreen (touch panel) technology has been very popular and used in a wide variety of different devices, including many mobile devices. As for the current touch panel technology, there are various methods of sensing the touch, such as resistive touchscreen technology, acoustic wave technology, capacitive touchscreen technology, infrared grid technology, optical imaging technology and dispersive signal technology, etc.

A resistive touchscreen panel may comprise several layers, the most important of which are two thin, transparent electrically-resistive layers separated by a thin space. Its disadvantages include the need to press down, and a risk of damage by sharp objects. Resistive touchscreens also suffer from poorer contrast, due to having additional reflections from the extra layer of material placed over the screen.

Acoustic wave technology uses ultrasonic waves that pass over the touchscreen panel. It can be damaged by exterior items. Contaminants on the can also interfere with the functionality of the touchscreen.

Capacitive touchscreen technology is one of the most popular methods available currently. A capacitive touchscreen panel consists of an insulator such as glass, coated with a transparent conductor such as indium tin oxide (ITO). As the human body is also an electrical conductor, touching the of the screen results in a distortion of the screen's electrostatic field, measurable as a change in capacitance. Different technologies may be used to determine the location of the touching point. The signal that contains the location information is then sent to the controller for processing.

capacitance is one primary type of capacitive touchscreen technology. Regarding this technology, only one side of the insulator is coated with a conductive layer. A small voltage is applied to the layer, resulting in a uniform electrostatic field. When a conductor, such as a human finger, touches a capacitor is dynamically formed. The sensor's controller then determines the location of the touching point indirectly from the changes of the capacitance as measured from the four corners of the panel. As it has no moving parts, such capacitive touch panel is pretty durable. However, it has limited resolution. In addition, it is prone to false signals from parasitic capacitive coupling as sometimes the true signals generated from the coupling of the finger and the sensor bar within a touchscreen is very weak or quite unstable. Moreover, a capacitive touchscreen may sometimes need to be calibrated.

In light of this, one primary objective of the present invention is to provide an applicable method to effectively enhance the generated coupling signal when a finger is touching a capacitive touch panel.

### BRIEF DESCRIPTION OF THE DRAWINGS

FIG. 1 shows a configuration of sensor bars and GND bars in a capacitive panel according to the present invention.

FIG. 2 is a schematic modified configuration with fishbone structures derived from the configuration illustrated in FIG. 1.

FIG. 3 is another schematic modified configuration with fishbone structures derived from the configuration illustrated in FIG. 1.

FIG. 4 illustrates a capacitive touch panel device according to the present invention.

### DETAILED DESCRIPTION OF THE INVENTION

All illustrations of the drawings and description of the embodiments are for the purpose of describing selected versions of the present invention and are not intended to limit the scope of the present invention.

The capacity touch panel has been used in various electronic devices, such as mobile phones and tablets. One side of the insulator (dielectric) is coated with a layer of conductive material; and a small voltage is applied to this layer to generate a uniform electrostatic field. When a finger touches the uncoated panel, a capacitor (conductor-dielectric-conductor) is dynamically formed. Accordingly, the sensing signal is generated from this capacitive coupling effect. Moreover, because of the sheet resistance of the panel, each corner is measured to have a different effective capacitance. Therefore, a connected controller (detector) can determine the location of the touching point indirectly from the changes in the capacitance as measured from the four corners of the touch panel. For example, the larger the change in capacitance, the closer the touching point is to that corner.

When a finger is touching the touch panel, a closed circuit of a capacitor will be formed. However, due to the fact that the ground (GND) potential of the human body (touching finger) and that of the touch panel device are not at the exact same potential level, the coupling capacitance generated following a finger touching is usually quite small. This will further lead to that the current change used to determine the touching location is too small to be correctly detected, or not very stable. As a result, the accuracy of the touch location is significantly compromised.

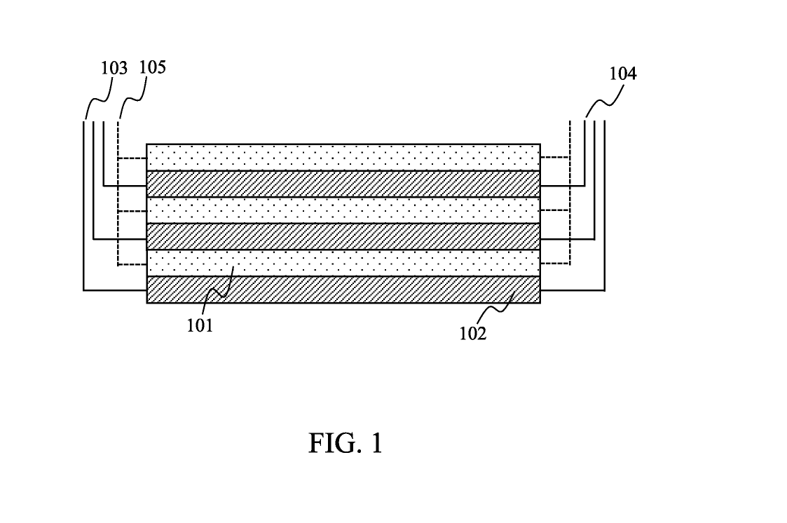

The present invention provides a signal enhancing method for a capacitive touch panel. A detailed description of the present invention is provided in connection with the accompanying drawings. With providing a reference (ground) potential and a new configuration of the sensor bar(s) in the touch panel, the present invention has significantly increased the coupling capacitance and current change on the sensor bar(s), which further helps to enhance the sensing signal generated following a finger touching and capacitive coupling effect. With reference to FIG. 1, it has demonstrated that in the present invention, the sensor bars 102 of the touch panel have be arranged in an alternative disposition with the DC ground (GND) bars 101. In practice, the GND bars and sensor bars of the touch panel could be generated by the approaches of chemical etching or laser etching to strip the ITO of the touch panel.

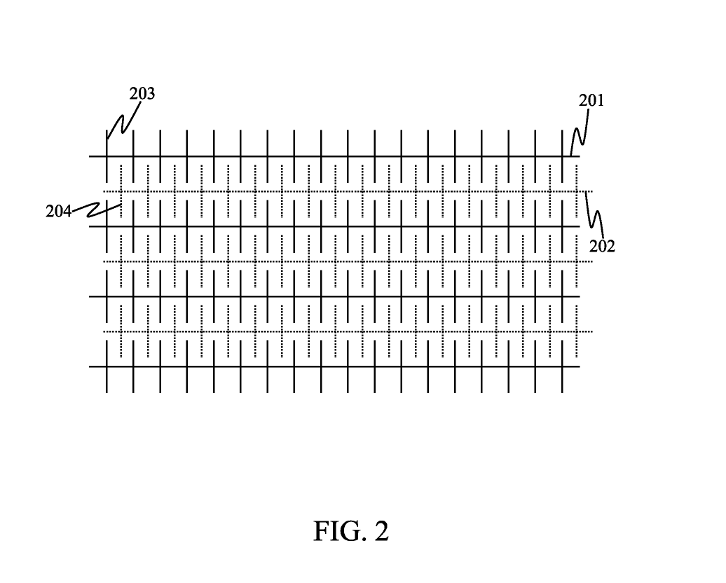

In another aspect of the present invention, with reference to FIG. 2, it provides a modified configuration of the sensor bar(s) and GND bar(s) on a touch panel with the addition of new fishbone-like sensor bar(s) and GND bar(s). In this modified configuration, the newly introduced multiple fishbone sensor bars 204 and fishbone GND bars 203 are arranged in an alternative way to further expand the parallel areas between the sensor bars 202, 204 and GND bars 201, 203. When a finger touching the parallel areas, both the neighboring sensor bar and GND bar would be touched simultaneously. In this way, the capacitive coupling effect and eventually the generated signal will be significantly enhanced. So, the main purpose of such arrangement of sensor bars and GND bars is to expand the parallel areas as large as possible.

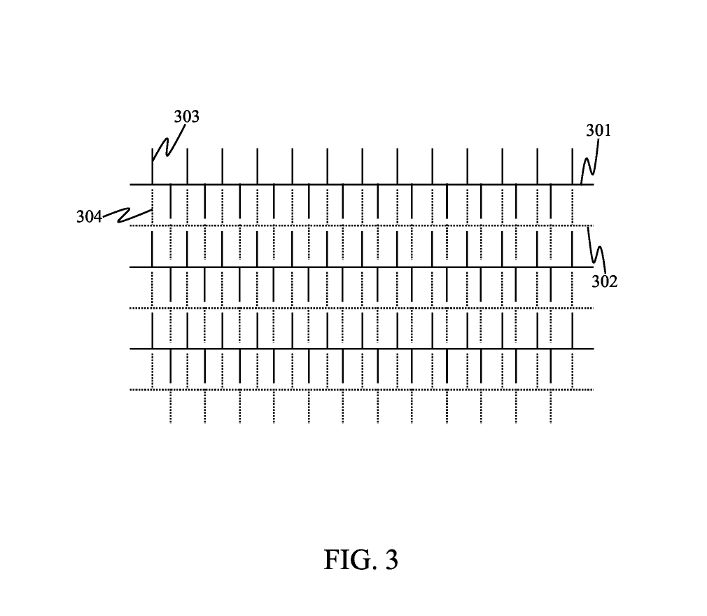

In yet another aspect of the present invention, with reference to FIG. 3, it has shown another alternatively arranged configuration of the fishbone sensor bars 304 and fishbone GND bars 303. It also significantly increases the parallel areas between the sensor bars 302, 304 and the GND bars 301, 303.

According to the configurations of the sensor bars and GND bars in FIG. 1, as well as of the fishbone sensor bars and fishbone GND bars as shown in FIGS. 2 and 3, within the touch panel, each tiny sensor bar always has a plurality of neighboring tiny GND bars around it; similarly, each tiny GND bar always has a plurality of neighboring tiny sensor bars around it. In this way, a significant number of expanded parallel areas with a GND bar next to a sensor bar are formed. All of these tiny GND bars are connected to the touch panel device's ground potential, such as its printed circuit board (PCB) ground line; and will function to provide the reference ground potential when a coupling capacitance is generated following a finger touch. Moreover, as shown in FIG. 1, sensor lines 103, 104 provided at the left and right ends of each sensor bar 101 are collectively connected to a flat panel cable (FPC) connector and then connected to a controller (detector); both are not shown in FIG. 1. Additionally, the tiny GND bars 101 are all connected to each other, and then connected to a GND potential of the touch panel device, such as to the PCB ground line. In this way, when a finger touches a tiny sensor bar 102, at least one tiny GND bar 101 adjacent to this tiny sensor bar 102 will also be touched. This is due to the fact that the touching area of a finger is generally much larger than the sizes of a tiny sensor bar and its neighboring tiny GND bar(s). So, there are usually more than one tiny sensor bars and more than one tiny GND bars within a touching area, and thus will be touched. Accordingly, with the involvement of the tiny GND bar(s) connected to the device's DC ground potential, such as the PCB ground line, a larger coupling capacitance will be generated following a finger touch. Because of this much larger coupling capacitance, the controller (detector) can detect a more significant current change on the touched sensor bar via the respective sensor lines 103, 104. As such, the controller can more easily determine the touching location based on the proportion of the detected signal magnitudes at the various corners of the touch panel.

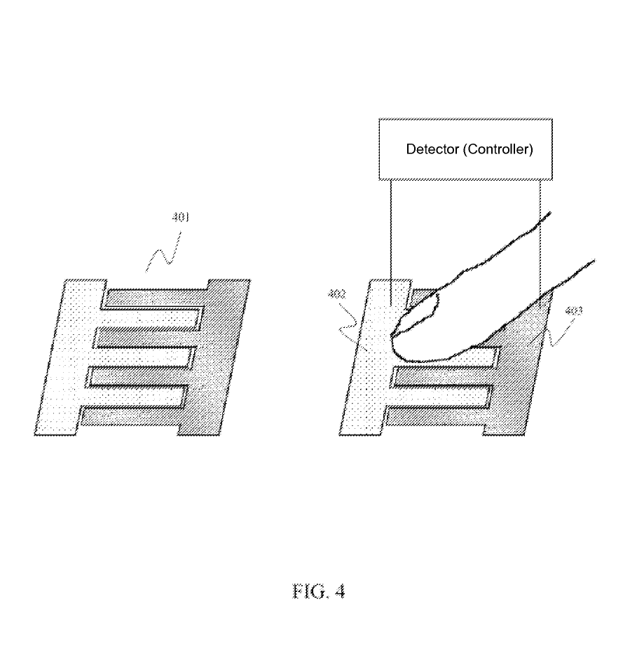

With reference to FIGS. 2 and 3, the signal enhancing method of the present invention as shown in FIG. 1 can be further modified to increase the aforementioned parallel areas with introducing fishbone sensor bars and fishbone GND bars. Fishbone sensor bars 204 are added to those tiny sensor bars 202, and fishbone GND bars 203 are added to those tiny GND bars 201, as shown in FIG. 2. Moreover, another signal enhancing method of the present invention has been illustrated in FIG. 3. In a different style, fishbone sensor bars 304 are added to the tiny sensor bars 302, and fishbone GND bars 303 are added to the tiny GND bars 301. As shown in FIG. 2 and FIG. 3, the fishbone sensor bars 204, 304 and the fishbone GND bars 203, 303 are disposed on the capacitive touch panel in an alternative arrangement. By employing these modified configurations, the parallel areas between the tiny sensor bars 202, 302 and the tiny GND bars 201, 301 have been significantly further expanded. Consequently, as shown in one touch panel device in FIG. 4, when a finger touches a device's touch panel 401 that comprises sensor bars and GND bars, certain sensor bar(s) 402 and their neighboring GND bar(s) 403 will be touched simultaneously. As the GND bars are connected to the device's ground potential, the generated coupling capacitor will have a larger coupling capacitance. As a result, a corresponding current change would be more significant and the obtained sensing signals would be with higher magnitudes.

Although the invention has been explained in relation to its preferred embodiment, it is to be readily understood that many other possible modifications and variations can be made without departing from the spirit and scope of the invention as hereinafter claimed.

What is claimed is:

1. A signal enhancing method for a capacitive touch panel of a mobile device, comprising:
providing a sensor bar;
providing a reference bar; and
arranging said reference bar next to said sensor bar in the capacitive touch panel.

2. The signal enhancing method for a capacitive touch panel of a mobile device of claim 1, comprising:
said reference bar providing a reference potential.

3. The signal enhancing method for a capacitive touch panel of a mobile device of claim 2, comprising:
said reference potential is a ground (GND) potential; and
said reference bar is a ground (GND) bar.

4. The signal enhancing method for a capacitive touch panel of a mobile device of claim 3, comprising:
said sensor bar comprising a plurality of tiny sensor bars;
said GND bar comprising a plurality of tiny GND bars; and
disposing said plurality of tiny sensor bars and said plurality of tiny GND bars in an alternative arrangement.

5. The signal enhancing method for a capacitive touch panel of a mobile device of claim 4, comprising:
said plurality of tiny sensor bars comprising fishbone sensor bars; and
said plurality of tiny GND bars comprising fishbone GND bars.

6. The signal enhancing method for a capacitive touch panel of a mobile device of claim 5, comprising:
disposing said fishbone sensor bars and said fishbone GND bars in an alternative arrangement.

7. The signal enhancing method for a capacitive touch panel of a mobile device of claim 6, comprising:
connecting said plurality of tiny sensor bars to a plurality of sensor lines;
connecting said plurality of sensor lines to a flat panel cable (FPC) connector; and
connecting said FPC connector to a controller.

8. The signal enhancing method for a capacitive touch panel of a mobile device of claim 6, comprising:
connecting said plurality of tiny GND bars together by a GND Line; and
connecting said GND line to a printed circuit board ground line of said mobile device.

9. A signal enhancing method for a capacitive touch panel of a mobile device, comprising:
providing a sensor bar;
providing a reference bar;
arranging said reference bar next to said sensor bar in the capacitive touch panel; and
said sensor bar comprising a plurality of tiny sensor bars.

10. The signal enhancing method for a capacitive touch panel of a mobile device of claim 9, comprising:
said reference bar providing a reference potential.

11. The signal enhancing method for a capacitive touch panel of a mobile device of claim 10, comprising:
said reference potential is a ground (GND) potential; and
said reference bar is a ground (GND) bar.

12. The signal enhancing method for a capacitive touch panel of a mobile device of claim 11, comprising:
said GND bar comprising a plurality of tiny GND bars; and
disposing said plurality of tiny sensor bars and said plurality of tiny GND bars in an alternative arrangement.

13. The signal enhancing method for a capacitive touch panel of a mobile device of claim 12, comprising:
said plurality of tiny sensor bars comprising fishbone sensor bars; and
connecting said plurality of tiny sensor bars to a plurality of sensor lines.

14. The signal enhancing method for a capacitive touch panel of a mobile device of claim 13, comprising:
said plurality of tiny GND bars comprising fishbone GND bars; and
disposing said fishbone sensor bars and said fishbone GND bars in an alternative arrangement.

15. The signal enhancing method for a capacitive touch panel of a mobile device of claim 14, comprising:
connecting said plurality of tiny GND bars together by a GND Line; and
connecting said GND line to a printed circuit board ground line of said mobile device.

16. The signal enhancing method for a capacitive touch panel of a mobile device of claim 15, comprising:
connecting said plurality of sensor lines to a flat panel cable (FPC) connector; and
connecting said FPC connector to a controller.

17. A signal enhancing method for a capacitive touch panel of a mobile device, comprising:
providing a sensor bar;
providing a reference bar;
arranging said reference bar next to said sensor bar in the capacitive touch panel;
said sensor bar comprising a plurality of tiny sensor bars;
connecting said plurality of tiny sensor bars to a plurality of sensor lines;
connecting said plurality of sensor lines to a flat panel cable (FPC) connector; and
connecting said FPC connector to a controller.

18. The signal enhancing method for a capacitive touch panel of a mobile device of claim 17, comprising:
said reference bar providing a reference potential;
said reference potential is a ground (GND) potential;
said reference bar is a ground (GND) bar;
said GND bar comprising a plurality of tiny GND bars;
connecting said plurality of tiny GND bars together by a GND Line; and
connecting said GND line to a printed circuit board ground line of said mobile device.

19. The signal enhancing method for a capacitive touch panel of a mobile device of claim 18, comprising:
said sensor bar comprising a plurality of tiny sensor bars; and
disposing said plurality of tiny sensor bars and said tiny GND bars in an alternative arrangement.

20. The signal enhancing method for a capacitive touch panel of a mobile device of claim 19, comprising:
said plurality of tiny sensor bars comprising fishbone sensor bars;
said plurality of tiny GND bars comprising fishbone GND bars; and
disposing said fishbone sensor bars and said fishbone GND bars in an alternative arrangement.
